(19) United States
(12) Patent Application Publication
(10) Pub. No.: US 2002/0189456 A1
(43) Pub. Date: Dec. 19, 2002

(54) External purge reservoir for air dryers

(75) Inventors: Fred Hoffman, Columbia Station, OH (US); Leonard Quinn, Elyria, OH (US); James P. Koenig, Olmstead Twp., OH (US)

Correspondence Address: CALFEE HALTER & GRISWOLD, LLP, 800 SUPERIOR AVENUE, SUITE 1400, CLEVELAND, OH, 44114, US

(73) Assignee: Honeywell Commercial Vehicle Systems Company

(21) Appl. No.: 09/880,280

(22) Filed: Jun. 13, 2001

(51) Int. Cl. B01D 53/02

(52) U.S. Cl. 96/110; 96/144

(57) ABSTRACT

A purge reservoir for an air dryer in an air brake system of a vehicle is disclosed. The purge reservoir or volume (24) is separate from the associated primary and secondary reservoirs of the air brake system. The purge volume (24) is secured directly to the air dryer housing (12) by fasteners (22). Purge volume (24) is operatively connected to air dryer housing (12) by opening (30) through which compressed air flows into purge reservoir (24) during the air dryer charge cycle, and through which purge air is supplied to the air dryer during the air dryer purge cycle. No air hoses are required for connecting the purge reservoir with the air dryer. Additionally, a desiccant cartridge (14) is fully accessible and may be replaced without otherwise disturbing the air dryer-purge reservoir module. Purge reservoir (24) also includes fastening capability (40) for securing the air dryer to the vehicle, thereby eliminating the need for a separate air dryer mounting bracket.

### BACKGROUND OF THE INVENTION

The invention pertains to air dryers, and has particular application to the combination of an air dryer with a purge volume for use as a module in a heavy vehicle air brake system.

Air dryers have been typically used to dry air in heavy vehicle air brake systems. The advantages of clean, dry air in air brake systems has long been recognized, as moisture entrained in an air brake system is susceptible to freezing during cold weather operation. This could lead to a wide range of possible brake malfunctions. Known air dryers include a desiccant through which the compressed air flows, thereby removing moisture. When the vehicle air compressor charges primary and secondary air reservoirs to a sufficient pressure level, typically around 120-130 p.s.i., the compressor is unloaded so that the compressor no longer compresses air. When the compressor is unloaded, a purge valve is opened and allows stored compressed air to flow back through the desiccant at a controlled rate to regenerate the desiccant by removing moisture adsorbed by the desiccant during the previous charge cycle.

The air used to regenerate the desiccant comes from a relatively small purge volume that is filled with compressed air during the compressor charge cycle. Several different designs are known for positioning the purge volume on the vehicle and interfacing the purge volume with the air dryer.

Some manufacturers provide the purge volume as an integral part of the air dryer. While simplifying installation, this approach has the disadvantage of limiting the purge volume capacity to a standardized capacity, which may be non-optimal for specific vehicle types and vehicle applications. For example, refuse trucks, transit buses, school buses, and related heavy vehicles typically use large amounts of brake air, whereas trucks used for interstate transport brake infrequently and therefore have much lower brake air usage. As will be appreciated, these different vehicle types and applications have distinctly different optimum purge volume capacities, which can only be accommodated by different air dryer/purge volume modules.

Structurally integrating the purge volume into the air dryer assembly limits access to the desiccant bed, thereby complicating desiccant replacement. One proposed solution of overcoming this latter difficulty is to integrate the purge volume into a desiccant bed cartridge which contains the desiccant material, so that the entire cartridge is easily replaced. However, this approach increases the desiccant bed cartridge size and cost.

Some other manufacturers avoid these disadvantages by using a separate purge volume remotely connected to the air dryer by lines or hoses, couplings, fittings, etc. However, this approach introduces difficulties including more complex field mounting and connection procedures, increased weight, an increased number of system components, and greater space occupancy versus an integrated air dryer/purge volume.

U.S. Pat. Nos. 5,917,139 and 6,074,462 are commonly assigned to the assignee of the present invention and teach an alternative approach where the purge volume is integrated into the secondary reservoir of the air brake system. The disclosures of these patents are incorporated herein by reference. These patents also teach reducing field assembly complexity by mounting the air dryer directly to the combination to form a single unit, air dryer/purge volume/secondary reservoir module. This approach improves access to the desiccant bed and eliminates air hoses between the dryer, the purge volume, and secondary reservoir. However, this approach has disadvantages including a large module size that is more difficult to position on selected heavy vehicles, and reduced flexibility in locating the air dryer relative to the compressor and the primary reservoir. This approach also retains the limiting standardized purge volume capacity of the integrated purge volume/air dryer approach.

Accordingly, there remains an unfulfilled need for an improved purge volume or reservoir for an air dryer. The invention contemplates such an improvement, which overcomes the above-described limitations and others.

### SUMMARY OF THE INVENTION

The present invention provides an improved air supply system, and particularly an external purge reservoir that does not require any external lines to connect an easily fabricated, optimized external reservoir to the dryer.

In accordance with one aspect of the present invention, an air supply system for a heavy vehicle brake system includes an air dryer that receives compressed air from a compressor. The air dryer includes a desiccant through which the compressed air flows to provide clean, dry air for operating the brake system. A purge volume stores compressed air used for regenerating the desiccant. The air dryer and the purge volume are interconnected together as a unitary module. The primary and secondary reservoirs of the air brake system are remotely located from the purge volume.

In accordance with yet another aspect of the present invention, a purge volume includes a hollow main body, a first surface forming a mounting bracket for securing the purge volume to the vehicle, and a second surface forming a mounting bracket for securing an air dryer to the purge volume. The second surface has an opening in communication with the air dryer whereby compressed air is introduced into the purge volume by the air dryer during an air dryer charge cycle, and purge air is introduced by the purge volume into the air dryer during an air dryer purge cycle.

One advantage of the present invention is that it eliminates the air lines between the air dryer and the purge volume.

Another advantage of the present invention is that it reduces the number of components, as well as weight and space requirements of the air dryer and purge volume by transforming these into a single module.

Still another advantage of the present invention is that it simplifies field installation by combining the air dryer and purge volume into a single module with included bracket.

Another advantage of the present invention is that it simplifies replacement of the desiccant by permitting greater access to the desiccant bed.

Another advantage of the present invention is that it reduces the size and cost of desiccant cartridges by separating the purge volume from the desiccant cartridge.

Yet another advantage of the present invention is that it facilitates using different purge volumes for different vehicle types and vehicle applications.

Still further advantages and benefits of the present invention will become apparent to those of ordinary skill in the art upon reading and understanding the following detailed description.

### BRIEF DESCRIPTION OF THE DRAWINGS

The invention may take form in various components and arrangements of components, and in various steps and arrangements of steps. The drawings are only for the purposes of illustrating preferred embodiments and are not to be construed as limiting the invention.

FIG. 1 shows an exploded perspective view of the air dryer-purge volume module.

FIG. 2 shows a view of a rear side of the purge volume.

FIG. 3 shows an alternate manner of securing the purge volume to the vehicle that includes a separate bracket.

FIG. 4 shows an exploded perspective view of an alternate embodiment of the air dryer-purge volume module.

FIG. 5 shows a perspective view of an alternate embodiment of the purge volume wherein the purge volume is essentially rectangular in cross-section.

### DETAILED DESCRIPTION OF THE PREFERRED EMBODIMENTS

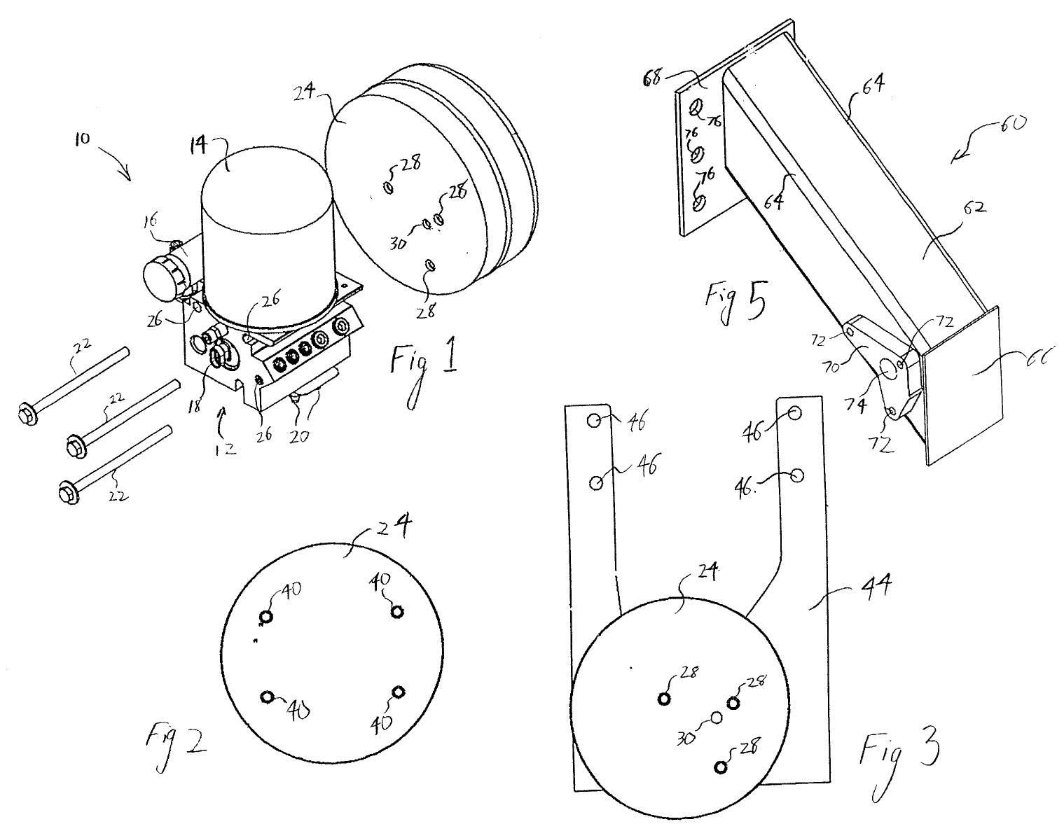

With reference to FIG. 1, an air dryer module 10 will be described. The module includes an air dryer housing 12 that contains a desiccant 14. The desiccant adsorbs moisture from compressed air during a charge cycle, thereby drying the compressed air. Unlike prior air dryers in which an integrated purge volume precluded access to the desiccant, in the present invention the desiccant is completely accessible. Preferably, a spin-on cartridge encloses the desiccant material, so that desiccant replacement during routine vehicle maintenance merely involves replacing the spin-on cartridge. The air dryer also includes, for example, a governor 16 for loading and unloading the air compressor, a heater/thermostat module 18 for temperature control, a plurality of pressure protection valves 20 for protecting against a rapid loss of pressure if either the primary or secondary systems fail, and various other air dryer components which are generally familiar to those skilled in the art.

Attached to the housing 12 is a purge reservoir or volume 24 which provides a reservoir for compressed air which is required by the air dryer during the purge cycle. Unlike the air dryer modules of U.S. Pat. Nos. 5,917,139 and 6,074,462 which teach incorporating the purge volume into the secondary reservoir, the purge volume of the present invention is a discrete element whose capacity is optimized to match the anticipated brake air usage of the heavy vehicle. Fasteners 22 are preferably long-shank bolts which pass completely through passages 26 in housing 12 and thread into openings of purge volume 24 whereby a single air dryer/purge reservoir module is formed. Of course, other fastening arrangements may be used without departing from the scope and intent of the invention.

Purge volume 24 operatively communicates with the housing 12 via opening 30 through which compressed air flows. During the charge cycle compressed air enters into purge volume 24 through opening 30, whereas during the purge cycle purge air reverse flows into the air dryer from the purge reservoir through opening 30. Unlike prior separated air dryer and purge volume units, the present invention advantageously eliminates the need for air hoses connecting the air dryer with the purge volume.

FIG. 2 shows the rear side of purge volume 24, i.e., that face of the reservoir that is spaced from the air dryer. The purge volume includes a fastener arrangement which allow purge reservoir 24 to serve as a mounting bracket for securing the air dryer to an associated vehicle. In the preferred embodiment these fasteners are nuts 40 disposed in a pattern that conforms to the vehicle. Thus, the present invention eliminates the need for a separate air dryer mounting bracket.

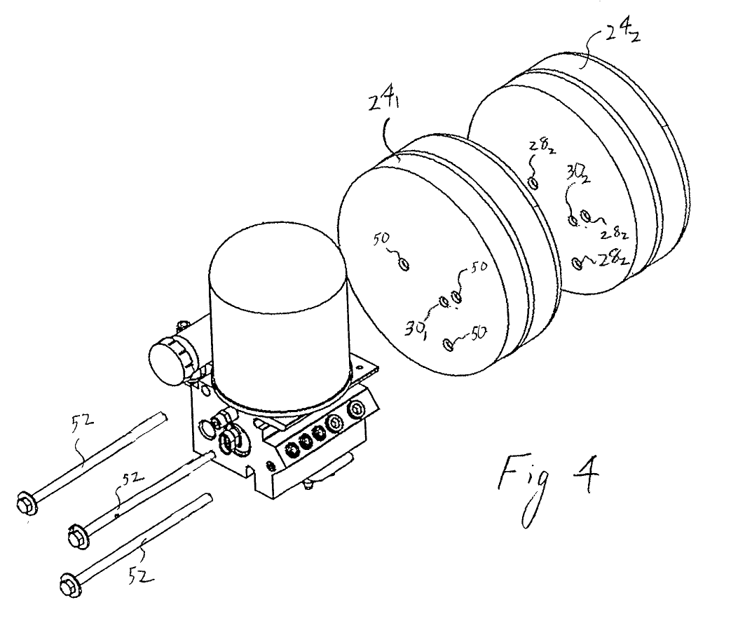

FIG. 3 shows an alternate air dryer mounting configuration, which is suitable for situations where it may be necessary to conform to an alternate vehicle-specific mounting bracket. It may be necessary, for example, to position the air dryer slightly away from the vehicle chassis. In these situations, a mounting bracket 44 is included. The air dryer assembly is secured to the bracket and the bracket is secured to the vehicle. Bracket 44 is dimensioned to optimally position the air dryer with respect to the vehicle chassis.

With reference to FIG. 4, another feature of the air dryer module is shown. Here, the purge volume itself is modular and demonstrates that the purge volume can adopt any desired volume. For example, two canisters 24, and 242 are illustrated and demonstrate that the volume can be easily modified by simply using the appropriately sized canister to meet vehicle needs. Thus, one skilled in the art will appreciate the flexibility in design offered by the present structure. Extended-length fasteners 52 may be required if the system requires an enlarged volume as provided by canister 24, while shorter fasteners can be used for the standard volume canister 242. In all other respects, the purge volume canisters are structurally and functionally identical.

Preferably, the purge reservoir is manufactured from tubing with end pieces. The tubing process permits a variety of purge reservoir shapes, and the capacity is easily varied over a wide range by properly selecting the tubing length.

In FIG. 5, a purge reservoir 60 having a rectangular cross-section is shown. This embodiment has a tubing main body 62 with chamfered or rounded corners 64 for increased mechanical strength. The main body is sealed by end pieces 66 and 68. End piece 68 is preferably modified to form the mounting bracket. The air dryer is connected to bracket piece 70 which includes nuts 72 and opening 74 for compressed air passage, and the air dryer including purge reservoir 60 is secured to the vehicle using fasteners 76.

The invention has been described with reference to the preferred embodiments. Obviously, modifications and alterations will occur to others upon reading and understanding the preceding detailed description. For example, although shapes and configurations are disclosed that are easily fabricated (e.g., rectangles, disks, etc.), the invention should not be construed as being limited to the particular configurations described herein. It will be appreciated that other conformations and changes can be made to achieve the modularity and desired optimization of the purge volume for special vehicle vocations. It is intended that the invention be construed as including all such modifications and alterations insofar as they come within the scope of the appended claims or the equivalents thereof.

Having thus described the preferred embodiments, the invention is now claimed to be:

1. An air supply system for an associated heavy vehicle brake system comprising:
a compressor for supplying compressed air;
an air dryer connected to receive compressed air from the compressor, and including a desiccant material through which the compressed air can flow to provide a dry compressed air source for operating the associated brake system;
a purge volume which stores compressed air used for regenerating the desiccant material, the purge volume spaced from the air dryer;
a housing connecting the air dryer and the purge volume together as a unitary module; and
a primary reservoir, located away from the purge volume.

2. The air supply system of claim 1, wherein the purge volume includes a bracket for securing the air dryer to an associated vehicle.

3. The air supply system of claim 2, wherein the purge volume includes:
a tubing main body; and
a plurality of end pieces closing opposite ends of the tubing.

4. The air supply system of claim 3, wherein at least one end piece forms a bracket for securing the air dryer to the associated vehicle.

5. The air supply system of claim 2, wherein the main body of the purge volume is essentially rectangular in cross-section.

6. The air supply system of claim 2, wherein the main body of the purge volume is essentially round in cross-section.

7. The air supply system of claim 1, wherein the purge volume includes a cylindrical element.

8. The air supply system of claim 7, further comprising control components disposed in the housing for controlling air flow from the compressor through the air dryer for charging at least the primary reservoir and the purge volume with compressed air, and for controlling air flow from the purge volume through the air dryer desiccant material to atmosphere to purge the air dryer.

9. A purge volume, used in conjunction with an associated air dryer in an associated air brake system of an associated vehicle, the purge volume comprising:
a hollow main body;
a first surface forming a mounting bracket for securing the purge volume to the vehicle; and
a second surface forming a mounting bracket for securing the air dryer to the purge volume, the second surface further having an opening in operative communication with the air dryer whereby:
compressed air flowing into the purge volume by the air dryer during an air dryer charge cycle, and
purge air flows from the purge volume into the air dryer during an air dryer purge cycle.

10. The purge volume as specified in claim 9, wherein the essentially hollow main body is a tubing.

11. The purge volume as specified in claim 10, wherein the tubing is closed by end pieces.
